(19) United States
(12) Patent Application Publication
(10) Pub. No.: US 2023/0409328 A1
(43) Pub. Date: Dec. 21, 2023

(54) PARALLEL PROCESSING ARCHITECTURE WITH MEMORY BLOCK TRANSFERS

(71) Applicant: Ascenium, Inc., Mountain View, CA (US)

(72) Inventor: Peter Foley, Los Altos Hills, CA (US)

(73) Assignee: Ascenium, Inc., Mountain View, CA (US)

(21) Appl. No.: 18/239,770

(22) Filed: Aug. 30, 2023

Related U.S. Application Data
(63) Continuation-in-part of application No. 17/526,003, filed on Nov. 15, 2021.
Application No. 17/526,003 is a continuation-in-part of application No. 17/465,949, filed on Sep. 3, 2021.
(60) Provisional application No. 63/529,159, filed on Jul. 27, 2023.
(60) Provisional application No. 63/460,909, filed on Apr. 21, 2023.
(60) Provisional application No. 63/447,915, filed on Feb. 24, 2023.
(60) Provisional application No. 63/442,131, filed on Jan. 31, 2023.
(60) Provisional application No. 63/424,960, filed on Nov. 14, 2022.
(60) Provisional application No. 63/424,961, filed on Nov. 14, 2022.
(60) Provisional application No. 63/402,490, filed on Aug. 31, 2022.
(60) Provisional application No. 63/254,557, filed on Oct. 12, 2021.
(60) Provisional application No. 63/232,230, filed on Aug. 12, 2021.
(60) Provisional application No. 63/229,466, filed on Aug. 4, 2021.
(60) Provisional application No. 63/193,522, filed on May 26, 2021.
(60) Provisional application No. 63/166,298, filed on Mar. 26, 2021.
(60) Provisional application No. 63/125,994, filed on Dec. 16, 2020.
(60) Provisional application No. 63/114,003, filed on Nov. 16, 2020.
(60) Provisional application No. 63/091,947, filed on Oct. 15, 2020.
(60) Provisional application No. 63/075,849, filed on Sep. 9, 2020.

(51) Int. Cl. G06F 9/345; G06F 9/30; G06F 9/54

(52) U.S. Cl. CPC G06F 9/3455; G06F 9/30149; G06F 9/544

(57) ABSTRACT

Techniques for task processing based on a parallel processing architecture with memory block transfers are disclosed. An array of compute elements is accessed. Each compute element is known to a compiler and is coupled to its neighboring compute elements. Control for the array is provided on a cycle-by-cycle basis. The control is enabled by a stream of wide control words generated by the compiler. A control word from the stream of control words includes a source address, a target address, a block size, and a stride. Memory block transfer control logic is used. The memory block transfer logic is implemented outside of the array of compute elements. A memory block transfer is executed. The memory block transfer is initiated by a control word from the stream of wide control words. Data for the memory block transfer is moved independently from the array of compute elements.

### RELATED APPLICATIONS

This application claims the benefit of U.S. provisional patent applications “Parallel Processing Architecture With Memory Block Transfers” Ser. No. 63/402,490, filed Aug. 31, 2022, “Parallel Processing Using Hazard Detection And Mitigation” Ser. No. 63/424,960, filed Nov. 14, 2022, “Parallel Processing With Switch Block Execution” Ser. No. 63/424,961, filed Nov. 14, 2022, “Parallel Processing With Hazard Detection And Store Probes” Ser. No. 63/442,131, filed Jan. 31, 2023, “Parallel Processing Architecture For Branch Path Suppression” Ser. No. 63/447,915, filed Feb. 24, 2023, “Parallel Processing Hazard Mitigation Avoidance” Ser. No. 63/460,909, filed Apr. 21, 2023, and “Parallel Processing Architecture With Block Move Support” Ser. No. 63/529,159, filed Jul. 27, 2023.

This application is also a continuation-in-part of U.S. patent application “Highly Parallel Processing Architecture With Compiler” Ser. No. 17/526,003, filed Nov. 15, 2021, which claims the benefit of U.S. provisional patent applications “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array” Ser. No. 63/193,522, filed May 26, 2021, “Parallel Processing Architecture For Atomic Operations” Ser. No. 63/229,466, filed Aug. 4, 2021, “Parallel Processing Architecture With Distributed Register Files” Ser. No. 63/232,230, filed Aug. 12, 2021, and “Load Latency Amelioration Using Bunch Buffers” Ser. No. 63/254,557, filed Oct. 12, 2021.

The U.S. patent application “Highly Parallel Processing Architecture With Compiler” Ser. No. 17/526,003, filed Nov. 15, 2021 is also a continuation-in-part of U.S. patent application “Highly Parallel Processing Architecture With Shallow Pipeline” Ser. No. 17/465,949, filed Sep. 3, 2021, which claims the benefit of U.S. provisional patent applications “Highly Parallel Processing Architecture With Shallow Pipeline” Ser. No. 63/075,849, filed Sep. 9, 2020, “Parallel Processing Architecture With Background Loads” Ser. No. 63/091,947, filed Oct. 15, 2020, “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array” Ser. No. 63/193,522, filed May 26, 2021, Parallel Processing Architecture For Atomic Operations” Ser. No. 63/229,466, filed Aug. 4, 2021, and “Parallel Processing Architecture With Distributed Register Files” Ser. No. 63/232,230, filed Aug. 12, 2021.

Each of the foregoing applications is hereby incorporated by reference in its entirety.

### FIELD OF ART

This application relates generally to task processing and more particularly to a parallel processing architecture with memory block transfers.

### BACKGROUND

Very large projects are generally made up of many small projects. Very often, the small projects are comprised of even smaller projects or tasks. The tasks themselves can be highly specialized and complex. As a result, such projects can require enormous resources in terms of financing, raw and fabricated materials, people, and time. The cathedral of Notre Dame in Paris took two hundred years to finish. The Duomo of Florence, Italy required one hundred forty-two years to build. Landing a man on the moon took more than eight years from the time that President Kennedy announced his intentions to the day Neil Armstrong stepped out onto the lunar surface. Over forty thousand engineers and technicians were involved in supporting the effort during the eight days of the Apollo 11 flight. Many more were involved over the eight years of effort from the early Mercury mission days to the completion of the Apollo missions.

Coordinating such large and complex projects requires huge amounts of effort on the part of management and operations staff. Managing and organizing labor and production efforts, developing and tracking manufacturing specifications, locating and hiring specialists, procuring materials, and so on are advanced skills in and of themselves. Each section of a project must be completed correctly, and the results must integrate properly with other sections that may be completed by separate teams, often in different locations across the country or the globe. The same sorts of challenges apply to information technology and data processing. Just as in the physical world, the coordination of digital networks, computer programs, and the data required to complete tasks in an efficient manner requires enormous amounts of skill and resources. Datasets used by various organizations can be organized differently, stored differently, and have varying levels of integrity. Many datasets hold millions or billions of records, with each record housing hundreds of individual pieces of data. The relationships between the records can be simple or extremely complicated. The database applications and storage systems used to house the data can vary widely in terms of technology and age. Some datasets are stored using well-known and widely supported commercial applications. Other data can be stored in proprietary databases created specifically for the data they hold. The careful management of such disparate datasets can contribute to the success of an organization or project. Poor management can easily cause an organization or project to fail.

To add to the complexity, data processing can require many different collection techniques. The data can come from a wide variety of sources, both human and digital. Citizens, customers, patients, purchasers, students, test subjects, and volunteers can all be involved in generating data for various organizations. Data collected from satellites, or from sensors in the oceans, in automobiles, in sewer systems, or in jumbo jets transporting hundreds of passengers are just a few of the vast number of digital systems that can generate mountains of data points. Data collection can be overt, subtle, or thoroughly hidden through means such as tracking purchase histories, website visits, button clicks, and menu choices. Regardless of the collection methods, the datasets can be vital to the project efforts of an organization, whether commercial, governmental, military, or civilian. Processing such vast amounts of disparate data in an effective and cost-efficient manner will continue to play a vital part in the lives of organizations large and small.

### SUMMARY

The success or failure of organizations directly depends on the efficient and effective completion of large numbers of processing jobs. Any of the processing jobs that are performed can directly impact operations and missions of the organizations. Typical processing jobs include analyzing research data, running billing, running payroll, training a neural network for machine learning, etc. These jobs are highly complex and are constructed from many individual tasks. The tasks can include loading and storing various datasets, accessing computational resources such as processing components and systems, executing data processing, and so on. The tasks are typically based on subtasks which themselves can be complex. The subtasks can be used to handle specific jobs, some of them “low-level”, such as loading or reading data from storage, performing computations and other manipulations on the data, storing or writing the data back to storage, handling inter-subtask communication such as data transfer and control, and so on. The datasets that are accessed are often immense. Such large amounts of data can easily overwhelm processing architectures based on inflexible designs that are simply ill suited to the processing tasks. Task processing efficiency and throughput are greatly improved through the use of arrays of elements for the processing of the tasks and subtasks. The arrays include compute elements, multiplier elements, registers, caches, queues, controllers, decompressors, arithmetic logic units (ALUs), storage elements, and other components which communicate among themselves. These arrays of elements are configured and operated by providing control to the array of elements on a cycle-by-cycle basis. The control of the array is accomplished by providing a stream of control words, where the control words can include wide control words generated by the compiler. The control words are used to configure the array, to control the flow or transfer of data, to perform memory block transfers, and to manage the processing of the tasks and subtasks. Further, the arrays can be configured in a topology which is best suited to the task processing. The topologies into which the arrays can be configured include a systolic, a vector, a cyclic, a spatial, a streaming, or a Very Long Instruction Word (VLIW) topology, among others. The topologies can include a topology that enables machine learning functionality.

Task processing is based on a parallel processing architecture with memory block transfers. An array of compute elements is accessed, wherein each compute element within the array of compute elements is known to a compiler and is coupled to its neighboring compute elements within the array of compute elements. Control is provided for the array of compute elements on a cycle-by-cycle basis, wherein the control is enabled by a stream of wide control words generated by the compiler. A memory block transfer is executed, wherein the memory block transfer is initiated by a control word from the stream of wide control words, and wherein data for the memory block transfer is moved independently from the array of compute elements.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a parallel processing architecture with memory block transfers.

FIG. 2 is a flow diagram for memory block transfer control.

FIG. 3 shows a high-level system block diagram for memory block transfer.

FIG. 4 illustrates a system block diagram for a highly parallel architecture with a shallow pipeline.

FIG. 5 shows compute element array detail.

FIG. 6 illustrates memory-to-memory data movement array detail.

FIG. 7 shows a system block diagram for compiler interactions.

FIG. 8 is a system diagram for a parallel processing architecture with memory block transfers.

### DETAILED DESCRIPTION

Techniques for a parallel processing architecture with memory block transfers are disclosed. The memory block transfers can include moving a number of bytes, words, and the like. The memory block can include a cache line. The memory block transfers are initiated by executing control words provided on a cycle-by-cycle basis. The control words, which include a stream of wide control words, are generated by a compiler. The memory block transfers support movement of control words, data, and the like to and from storage such as one or more levels of cache memory or a memory system. The control words and data are provided to one or more compute elements within an array of compute elements. The compute elements are configured or scheduled to execute tasks, subtasks, processes, etc. The memory block transfers can provide data to one or more compute elements prior to the data being required for processing by a task, subtask, process, etc. The memory block transfers can be accomplished using memory block transfer control logic. The memory block transfer control logic operates autonomously from the array of compute elements.

A control word from the stream of wide control words includes a source address, a target address, a block size, and a stride. The source and target addresses can be associated with cache memory or a memory system. The block size can include a number of bytes, words, and the like. The stride can describe the size of a data element. Memory block transfer control logic is used for the memory block transfers. The memory block transfer control logic computes memory addresses. The memory addresses are associated with cache storage. If the requested addresses are not available in the cache, a cache miss occurs and the memory addresses are provided to the memory system. The memory block transfer control logic is implemented outside of the array of compute elements. The memory block transfer control logic operates autonomously from the array of compute elements, thereby enabling processing by compute elements within the array to continue while memory block transfer is occurring. The memory block transfer control logic can be augmented by configuring one or more compute elements from the array of compute elements. The configuring of the one or more compute elements initializes compute element operation buffers. The operation buffers comprise bunch buffers. The memory block transfer can include a load and/or store forwarding operation, a cache line move, and so on. The cache line move transfers data on unidirectional line transfer buses.

The data manipulations are performed on an array of compute elements. The compute elements within the array can be implemented with central processing units (CPUs), graphics processing units (GPUs), application specific integrated circuits (ASICs), field programmable gate arrays (FPGAs), processing cores, or other processing components or combinations of processing components. The compute elements can include heterogeneous processors, homogeneous processors, processor cores within an integrated circuit or chip, etc. The compute elements can be coupled to local storage which can include local memory elements, register files, cache storage, etc. The cache, which can include a hierarchical cache, such as a level 1 (L1), a level 2 (L2), and a level 3 (L3) cache working together, can be used for storing data such as intermediate results, compressed control words, coalesced control words, decompressed control words, relevant portions of a control word, and the like. The cache can store data produced by a taken branch path, where the taken branch path is determined by a branch decision. The decompressed control word is used to control one or more compute elements within the array of compute elements. The array of compute elements can comprise two-dimensional (2D) arrays of compute elements. Multiple layers of the two-dimensional (2D) array of compute elements can be “stacked” to comprise a three-dimensional array of compute elements.

The tasks, subtasks, etc., that are associated with data processing operations are generated by a compiler. The compiler can include a general-purpose compiler, a hardware description-based compiler, a compiler written or “tuned” for the array of compute elements, a constraint-based compiler, a satisfiability-based compiler (SAT solver), and so on. Control is provided to the hardware in the form of control words, where one or more control words are generated by the compiler. The control words are provided to the array on a cycle-by-cycle basis. The control words can include wide microcode control words. The length of a microcode control word can be adjusted by compressing the control word. The compressing can be accomplished by identifying processing situations where a compute element is unneeded by a task. Thus, control bits within the control word associated with the unneeded compute elements are not required for that compute element. Other compression techniques can also be applied. The control words can be used to route data, to set up operations to be performed by the compute elements, to idle individual compute elements or rows and/or columns of compute elements, etc. The compiled microcode control words associated with the compute elements are distributed to the compute elements. The compute elements are controlled by a control unit which decompresses the compressed control words. The decompressed control words enable processing by the compute elements. The task processing is enabled by executing the one or more control words. In order to accelerate the execution of tasks, to reduce or eliminate stalling for the array of compute elements, and so on, memory block transfers can be accomplished by memory block transfer control logic autonomously from the array of compute elements. The autonomous memory block transfer can occur while the array is processing other data without interrupting the processing. The memory block transfer can further transfer data prior to the data being required for processing.

A parallel processing architecture with memory block transfers enables task processing. The task processing can include manipulation of a variety of data types. An array of compute elements is accessed, wherein each compute element within the array of compute elements is known to a compiler and is coupled to its neighboring compute elements within the array of compute elements. The compute elements can include compute elements, processors, or cores within an integrated circuit; processors or cores within an application specific integrated circuit (ASIC); cores programmed within a programmable device such as a field programmable gate array (FPGA); and so on. The compute elements can include homogeneous or heterogeneous processors. Each compute element within the array of compute elements is known to a compiler. The compiler, which can include a general-purpose compiler, a hardware-oriented compiler, or a compiler specific to the compute elements, can compile code for each of the compute elements. Each compute element is coupled to its neighboring compute elements within the array of compute elements. The coupling of the compute elements enables data communication between and among compute elements. Thus, the compiler can control data flow between and among the compute elements and can further control data commitment to memory outside of the array. Control for the array of compute elements is provided on a cycle-by-cycle basis, wherein the control is enabled by a stream of wide control words generated by the compiler. A cycle can include a clock cycle, an architectural cycle, a system cycle, etc. The stream of wide control words generated by the compiler provides direct, fine-grained control of the array of compute elements. The fine-grained control can include control of individual compute elements, memory elements, control elements, etc. The control word from the stream of wide control words includes a source address, a target address, a block size, and a stride. Memory block transfer control logic is used to compute memory addresses. The memory block transfer control logic is implemented outside of the array of compute elements and can be augmented by configuring one or more compute elements from the array of compute elements. A memory block transfer is executed, wherein the memory block transfer is initiated by a control word from the stream of wide control words, and wherein data for the memory block transfer is moved independently from the array of compute elements. A control unit is notified upon successful completion of the memory block transfer.

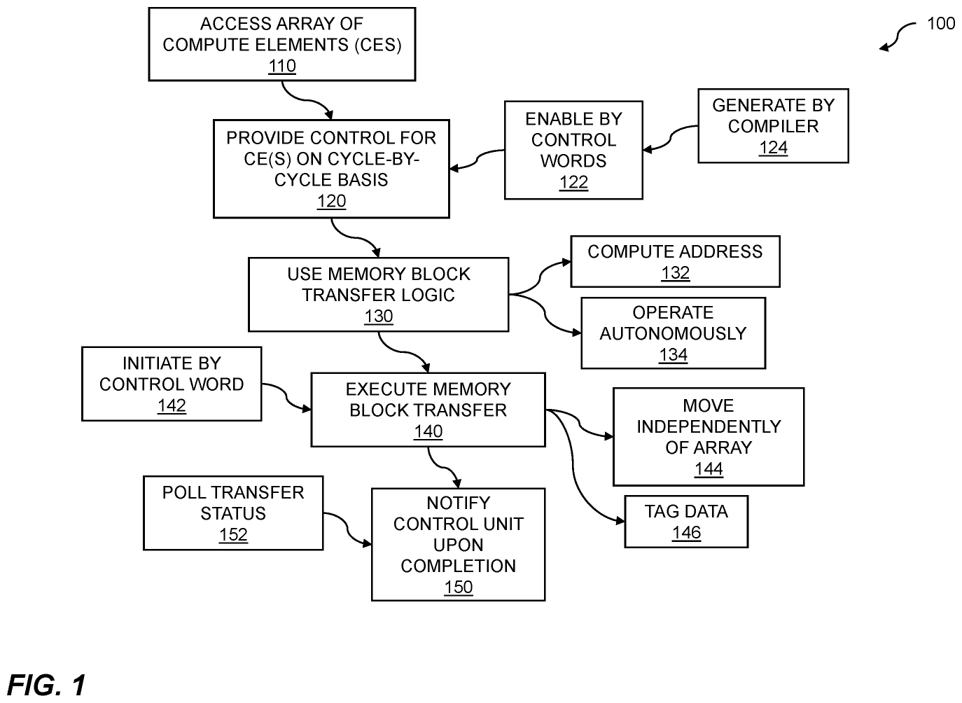

FIG. 1 is a flow diagram for a parallel processing architecture with memory block transfers. Groupings of compute elements (CEs), such as CEs assembled within an array of CEs, can be configured to execute a variety of operations associated with data processing. The operations can be based on tasks, and on subtasks that are associated with the tasks. The array can further interface with other elements such as controllers, storage elements, ALUs, memory management units (MMUs), GPUs, multiplier elements, and so on. The operations can accomplish a variety of processing objectives such as application processing, data manipulation, data analysis, and so on. The operations can manipulate a variety of data types including integer, real, and character data types; vectors and matrices; tensors; etc. Control is provided to the array of compute elements on a cycle-by-cycle basis, where the control is based on control words generated by a compiler. The control words, which can include microcode control words, enable or idle various compute elements; provide data; route results between or among CEs, caches, and storage; and the like. The control enables compute element operation, memory access precedence, etc. Compute element operation and memory access precedence enable the hardware to properly sequence data provision and compute element results. The control enables execution of a compiled program on the array of compute elements.

The flow 100 includes accessing an array 110 of compute elements, wherein each compute element within the array of compute elements is known to a compiler and is coupled to its neighboring compute elements within the array of compute elements. The compute elements can be based on a variety of types of processors. The compute elements, or CEs, can include central processing units (CPUs), graphics processing units (GPUs), processors or processing cores within application specific integrated circuits (ASICs), processing cores programmed within field programmable gate arrays (FPGAs), and so on. In embodiments, compute elements within the array of compute elements have identical functionality. The compute elements can include heterogeneous compute resources, where the heterogeneous compute resources may or may not be colocated within a single integrated circuit or chip. The compute elements can be configured in a topology, where the topology can be built into the array, programmed or configured within the array, etc. In embodiments, the array of compute elements is configured by a control word that can implement a topology. The topology that can be implemented can include one or more of a systolic, a vector, a cyclic, a spatial, a streaming, or a Very Long Instruction Word (VLIW) topology.

The compute elements can further include a topology suited to machine learning computation. A topology for machine learning can include supervised learning, unsupervised learning, reinforcement learning, and other machine learning topologies. The compute elements can be coupled to other elements within the array of CEs. In embodiments, the coupling of the compute elements can enable one or more further topologies. The other elements to which the CEs can be coupled can include storage elements such as one or more levels of cache storage; control units; multiplier units; address generator units for generating load (LD) and store (ST) addresses; memory block transfer control logic for computing memory addresses; queues; register files; and so on. The compiler to which each compute element is known can include a C, C++, or Python compiler. The compiler to which each compute element is known can include a compiler written especially for the array of compute elements. The coupling of each CE to its neighboring CEs enables clustering of compute resources; sharing of elements such as cache elements, multiplier elements, ALU elements, or control elements; communication between or among neighboring CEs; and the like.

The flow 100 includes providing control 120 for the array of compute elements on a cycle-by-cycle basis. The controlling the array can include configuration of elements such as compute elements within the array; loading and storing data; routing data to, from, and among compute elements; and so on. A cycle can include a clock cycle, an architectural cycle, a system cycle, a self-timed cycle, and the like. In the flow 100, the control is enabled 122 by a stream of wide control words. The control words can include microcode control words, compressed control words, encoded control words, and the like. The “wideness” or width of the control words allows a plurality of compute elements within the array of compute elements to be controlled by a single wide control word. For example, an entire row of compute elements can be controlled by that wide control word. In embodiments, the stream of wide control words can include variable length control words generated by the compiler. The control words can be decompressed, used, etc., to configure the compute elements and other elements within the array; to enable or disable individual compute elements, rows and/or columns of compute elements; to load and store data; to route data to, from, and among compute elements; and so on. In other embodiments, the stream of wide, variable length, control words generated by the compiler can provide direct, fine-grained control of the array of compute elements. The fine-grained control of the compute elements can include enabling or idling individual compute elements; enabling or idling rows or columns of compute elements; etc.

The one or more control words are generated 124 by the compiler. The compiler which generates the control words can include a general-purpose compiler such as a C, C++, or Python compiler; a hardware description language compiler such as a VHDL or Verilog compiler; a compiler written for the array of compute elements; and the like. In embodiments, the wide control words comprise variable length control words. In embodiments, the stream of wide control words generated by the compiler provides direct, fine-grained control of the array of compute elements. The compiler can be used to map functionality to the array of compute elements. In embodiments, the compiler can map machine learning functionality to the array of compute elements. The machine learning can be based on a machine learning (ML) network, a deep learning (DL) network, a support vector machine (SVM), etc. In embodiments, the machine learning functionality can include a neural network (NN) implementation. The neural network implementation can include a plurality of layers, where the layers can include one or more of input layers, hidden layers, output layers, and the like. A control word generated by the compiler can be used to configure one or more CEs, to enable data to flow to or from the CE, to configure the CE to perform an operation, and so on. Depending on the type and size of a task that is compiled to control the array of compute elements, one or more of the CEs can be controlled, while other CEs are unneeded by the particular task. A CE that is unneeded can be marked in the control word as unneeded. An unneeded CE requires no data and no control word. In embodiments, the unneeded compute element can be controlled by a single bit. In other embodiments, a single bit can control an entire row of CEs by instructing hardware to generate idle signals for each CE in the row. The single bit can be set for “unneeded”, reset for “needed”, or set for a similar usage of the bit to indicate when a particular CE is unneeded by a task.

The control words that are generated by the compiler can include a conditionality such as a branch. The branch can include a conditional branch, an unconditional branch, etc. The control words can be decompressed by a decompressor logic block that decompresses words from a compressed control word cache on their way to the array. In embodiments, the set of directions can include a spatial allocation of subtasks on one or more compute elements within the array of compute elements. In other embodiments, the set of directions can enable multiple, simultaneous programming loop instances circulating within the array of compute elements. The multiple programming loop instances can include multiple instances of the same programming loop, multiple programming loops, etc.

The flow 100 includes using memory block transfer control logic 130. The block transfer control logic can be used to set up a block transfer, execute a block transfer, report status and results of a block transfer, and so on. The memory block transfer control logic can be controlled by one or more control words from the stream of wide control words generated by the compiler. In embodiments, the control word from the stream of wide control words can include a source address, a target address, a block size, and a stride. The source address and the target address can refer to locations or addresses associated with storage elements. The storage elements can include storage elements within the array of compute elements, cache memory, a memory system, and the like. The block size can refer to a quantity of bits, bytes, words, etc. that can be associated with a block for transfer. The stride can refer to a “size” of a data element, where the size can be based on a quantity of bits, bytes, etc.

The memory block transfer control block can perform one or more operations, tasks, and so on associated with a memory block transfer. In the flow 100, the memory block transfer control logic computes memory addresses 132. The memory addresses can be computed from the source destination and destination address provided by the control word. The computed memory addresses can refer to a memory block that can be located within a cache memory, a memory system, and so on. The cache memory system can include a small, fast memory that can be located in close proximity to or adjacent to the array of compute elements. The cache memory can include one or more layers of memory. Each successive layer of the cache can be substantially similar in size to or larger than the previous level of the cache. In embodiments, the cache memory can comprise three or more levels of cache such as a level 1 (L1) cache, a level 2 (L2) cache, a level 3 (L2) cache, etc. The memory system can include a large, relatively slow memory in comparison to the cache. The computed memory block addresses are first compared to the contents of the cache levels to determine whether the memory block identified for transfer is located in the levels of small, fast memory. If the memory block is not found in the cache, then a cache miss event occurs. In the event of a cache miss, the memory block identified for transfer is sought within a larger, slower memory, such as the memory system. The memory addresses can include actual physical memory addresses in the cache. A physical address can exist after being translated by a memory management unit (MMU). The memory addresses in the L1 data cache can include virtually indexed, physically tagged (VIPT) entries, which are hybrid physical addresses, that is, the address comprises a virtual index pointer, but is tagged to a physical location within the data cache.

In embodiments, the memory block transfer control logic can be implemented outside of the array of compute elements. The memory block transfer control logic can be implemented as a purpose-built controller; a control element that can be configured, programmed, or scheduled for memory block transfer control; and so on. The control logic can execute one or more control words generated by the compiler. The memory block transfer control logic can be controlled by control words executed by the array of compute elements or by substantially different control words. In the flow 100, the memory block transfer control logic operates autonomously 134 from the array of compute elements. The autonomous operation enables the memory block transfer control logic to transfer memory blocks while one or more compute elements within the array of compute elements are executing operations associated with tasks, subtasks, etc. The autonomous operation can enable data associated with transferred memory blocks to be moved prior to processing of the data, without interrupting execution of the tasks and subtasks.

In embodiments, the memory block transfer control logic can be augmented by configuring one or more compute elements from the array of compute elements. The configuring of the one or more compute elements can be accomplished using one or more control words generated by the compiler. The one or more compute elements can be configured for functions such as processing, communication, storage, and so on. In embodiments, the configuring can initialize compute element operation buffers within the one or more compute elements. The operation buffers can be used to hold or load data; to store data, control words, or portions of control words; and the like. The operation buffers can be used to accumulate loaded or stored data, to retime data, etc. The retiming data can be used to hold data that arrives asynchronously for synchronous delivery to a compute element. In embodiments, the operation buffers can include bunch buffers. Herein, a “bunch” can include a group of bits in a control word that controls a single compute element. Essentially, each bunch buffer can contain the bits (i.e., “bunch”) that would otherwise be driven into the array to control a given compute element. In addition, a compute element may include its own small “program counter” to index into the bunch buffer and may also have the ability to take a “micro-branch” within that compute element. For physically close clusters of compute elements, the “micro-branch” decisions can be broadcast to all cooperating members of a group or cluster. The bunch buffer can comprise a one read port and one write port (1R1W) register. Alternatively, the registers can be based on a memory element with two read ports and one write port (2R1W). The 2R1W memory element enables two read operations and one write operation to occur substantially simultaneously. A bunch can further include a bunch of control words.

In embodiments, the memory block transfer can include a load and/or store forwarding operation. A load and/or store forwarding operation can accomplish the memory block transfer without passing the memory block through the compute element array. In a usage example, data originating in the cache memory can traverse a crossbar switch, line transfer buses (discussed shortly), or access buffers to forward data from a source address to a target address. The memory block transfer can therefore be accomplished without sending the memory block through the array. As a result, the array can continue execution of operations associated with tasks and subtasks without having to stop the processing to accomplish the memory block transfer. In other embodiments, the memory block transfer can include a cache line move. A cache line can include an amount of data such as a quantity of bytes that can be transferred between the cache and the memory system. The cache line, also referred to as a data block, contains the actual data loaded from or stored to the memory system. One or more buses can be allocated to the loading and/or storing of a cache line. In embodiments, the cache line move can transfer data on unidirectional line transfer buses.

The flow 100 includes executing 140 a memory block transfer. The executing the memory block transfer can be based on one or more control words. The executing can be based on setting up the source address, locating the data associated with the source address, transferring the data by reserving and using unidirectional buses, setting up the destination address, storing the data to the destination address, and so on. In embodiments, data for the memory block transfer can be non-cacheable. Non-cacheable data herein refers to data that cannot be written to cache memory because doing so would overwrite valid data required by another task, subtask, and the like. In the flow 100, the memory block transfer can be initiated 142 by a control word from the stream of wide control words. Recall that the control word from the stream of wide control words includes the source address, the destination address, a block size, and a stride. In the flow 100, data for the memory block transfer is moved independently 144 of the array of compute elements. The memory block transfer can be accomplished using one or more of a crossbar switch, a transfer buffer, or unidirectional line transfer buses. By accomplishing the memory block transfer independently of the array, the compute elements within the array can continue executing operations associated with control words without having to halt or suspend execution in order to accomplish the memory block transfer. An identifier can be associated with a cache line or other unit of data. The flow 100 includes tagging 146 data to enable cache line movement. The tagging can be accomplished using an identifier, a label, and so on. In other embodiments, the tagging data can be performed on data issuing from the array of compute elements. The tagging can be accomplished by the compiler, a controller, etc. In embodiments, the tagging can include associating a countdown tag with a cache line. The countdown tag can represent an amount of time or a number of cycles, such as architectural cycles or physical cycles, that can be allowed for transferring a memory block.

The flow 100 further includes notifying 150 a control unit upon successful completion of the memory block transfer. The notifying the control unit can be based on sending a signal or message, setting a flag or semaphore, and so on. The successful completion can be based on storing a memory block at the destination address within a number of cycles, an amount of time, and the like. In embodiments, successful completion of the memory block transfer can occur within an architectural cycle. An architectural cycle can be based on one or more physical cycles associated with the array, an amount of time, etc. In embodiments, the architectural cycle includes a plurality of clock cycles. A clock cycle can comprise a “wall clock” cycle or real time cycle. In the flow 100, the notifying is accomplished by polling 152 the memory block transfer status. The memory block transfer status can include pending, initiating, in-process, complete, failed, time-out, and so on. In embodiments, the memory block transfer status can be based on the tag associated with the memory block being transferred.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

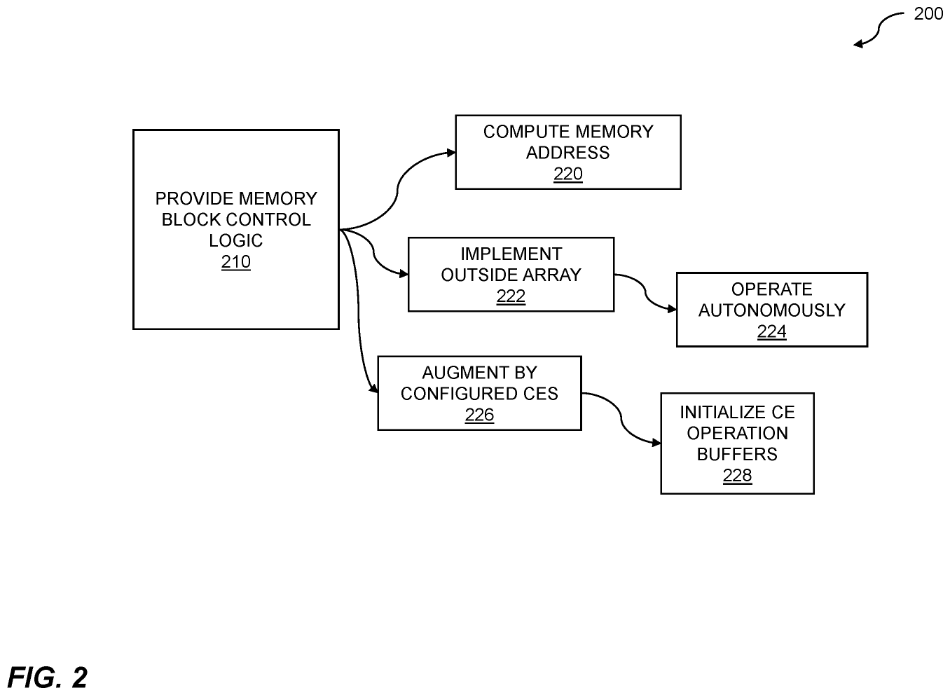

FIG. 2 is a flow diagram for memory block transfer control. A memory block can be transferred between a memory system and a cache memory, between cache memories, and so on. Collections or clusters of compute elements (CEs), such as CEs assembled within an array of CEs, can be configured to execute a variety of operations associated with programs. The operations can be based on tasks, and on subtasks that are associated with the tasks. The array can further interface with other elements such as controllers, storage elements, ALUs, MMUs, GPUs, multiplier elements, and the like. The operations can accomplish a variety of processing objectives such as application processing, data manipulation, design and simulation, and so on. The operations can perform manipulations of a variety of data types including integer, real, floating-point, and character data types; vectors and matrices; tensors; etc. Control is provided to the array of compute elements on a cycle-by-cycle basis, where the control is based on a stream of wide control words generated by a compiler. The control words, which can include microcode control words, can enable or idle various compute elements; provide data; route results between or among CEs, caches, and storage; and the like. The control enables compute element operation, memory access precedence, etc. Compute element operation and memory access precedence enable the hardware to properly sequence compute element results.

The control enables execution of a compiled program on the array of compute elements. The compute elements can access registers that contain control words, data, and so on. To simplify application coding, task processing, etc., virtual registers can be used. The virtual registers can be represented by the compiler, and the virtual registers can be mapped to at least two physical registers. The virtual registers enable a parallel processing architecture using distributed register files. An array of compute elements is accessed, wherein each compute element within the array of compute elements is known to a compiler and is coupled to its neighboring compute elements within the array of compute elements. The array of compute elements is controlled on a cycle-by-cycle basis, wherein the controlling is enabled by a stream of wide control words generated by the compiler. Virtual registers are mapped to a plurality of physical register files distributed among one or more of the compute elements, wherein the mapping is performed by the compiler. Operations contained in the control words are executed, wherein the operations are enabled by at least one of the plurality of distributed physical register files.

The flow 200 includes providing 210 memory block transfer logic. The memory block transfer control logic can include logic associated with an array of compute elements, a logic component accessible by the array, and so on. The memory block transfer logic can include logic that can be configured, scheduled, programmed, and so on to manage memory block transfers between a cache and a memory system, between caches, etc. The memory block transfer control logic can be controlled by a control word from a stream of wide control words generated by a compiler. The control word from the stream of wide control words includes a source address, a target address, a block size, and a stride. The compute elements can be based on a variety of types of processors. The compute elements or CEs can include central processing units (CPUs), graphics processing units (GPUs), processors or processing cores within application specific integrated circuits (ASICs), processing cores programmed within field programmable gate arrays (FPGAs), and so on. In embodiments, compute elements within the array of compute elements have identical functionality. The compute elements can include heterogeneous compute resources, where the heterogeneous compute resources may or may not be colocated within a single integrated circuit or chip. The compute elements can be configured in a topology, where the topology can be built into the array, programmed or configured within the array, etc. In embodiments, the array of compute elements is configured by a control word to implement one or more of a systolic, a vector, a cyclic, a spatial, a streaming, or a Very Long Instruction Word (VLIW) topology.

In the flow 200, the memory block transfer control logic computes memory addresses 220. The memory addresses can reference a memory block source location, a memory block destination location, and so on. The addresses of the source location and the destination location can include addresses associated with one or more levels of cache memory, a memory system, and the like. The cache memory can include a multilevel cache, where the multilevel cache can include a level 1 (L1) cache, a level 2 (L2) cache, a level 3 (L3) cache, etc. The cache memory can include a small, fast, local memory. The addresses computed by the memory block transfer control logic can first be compared against the contents of the cache. In a usage example, a memory block can be selected for transfer. The search for the block can include comparing the computed addresses to the contents of the L1 cache. If the block is not located in the L1 cache, a cache miss occurs, and the block is sought in the L2 cache. If the block is not found in the L2 cache, then a cache miss occurs, and the block is sought in the L3 cache. If the block is not found in the L3 cache, then a cache miss occurs, and the block is sought in the memory system. If the block associated with the memory address computed by the memory block transfer control logic is found in one of the levels of cache, then the time required to access the block is significantly less than the time needed to access the block in the memory system.

In the flow 200, the memory block transfer control logic can be implemented 222 outside of the array of compute elements. The memory block transfer control logic can include a specialized or customized controller; a control element that can be configured, scheduled, or programmed; and so on. The control logic can access the array of compute elements, memory, and the like using communications channels, buses, a network connection, and the like. The memory block transfer control logic can transfer a memory block using a bus independent of the array. The memory block transfer can include a number of bytes, words, etc. In embodiments, the memory block transfer can include a cache line move. The block transfer can include a plurality of cache line moves. In embodiments, the cache line move can transfer data on unidirectional line transfer buses. In the flow 200, the memory block transfer control logic can operate autonomously 224 from the array of compute elements. The autonomous operation of the block transfer control logic enables movement of memory blocks while one or more compute elements within the array of compute elements can continue executing one or more operations related to control words associated with tasks and subtasks. The tasks and subtasks can be associated with processing tasks.

In the flow 200, the memory block transfer control logic can be augmented 226 by configuring one or more compute elements from the array of compute elements. The one or more configured compute elements can be used for data processing associated with computing memory addresses. Recall that the compute elements can be configured for communication, storage, etc., in addition to being configured for processing. In the flow 200, the configuring can initialize compute element operation buffers 228 within the one or more compute elements. The operation buffers can include input buffers, output buffers, retiming buffers, temporary storage, and the like. In embodiments, the operation buffers can include bunch buffers. Discussed previously, control words are based on bits. Sets of control word bits, or “bunches”, can be loaded into buffers called bunch buffers. The bunch buffers are coupled to compute elements and can control the compute elements. The control word bunches are used to configure the array of compute elements, and to control the flow or transfer of data within and the processing of the tasks and subtasks on the compute elements within the array.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

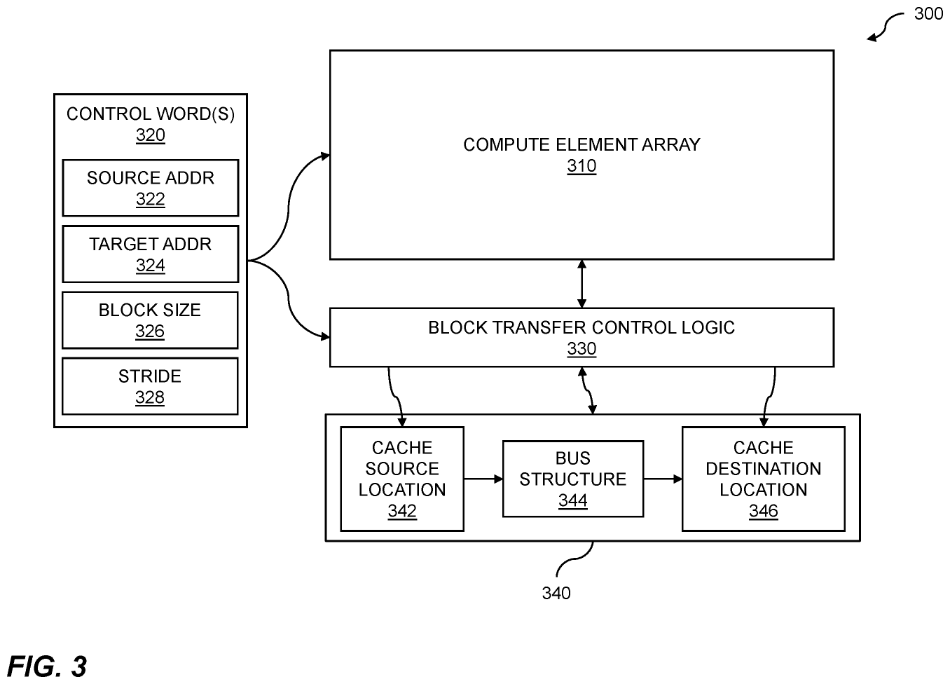

FIG. 3 shows a high-level system block diagram for memory block transfer. Memory block transfer can be accomplished between a source location and a destination location. The source location and the destination location can include locations with cache memory, where the cache memory can include one or more levels of cache. The one or more levels of cache memory can include a level 1 (L1) cache, a level 2 (L2) cache, a level 3 (L3) cache, and so on. The memory block transfer can be performed autonomously from an array of compute elements. The memory block transfer enables a parallel processor architecture for task processing. An array of compute elements is accessed, wherein each compute element within the array of compute elements is known to a compiler and is coupled to its neighboring compute elements within the array of compute elements. Control for the array of compute elements is provided on a cycle-by-cycle basis, wherein the control is enabled by a stream of wide control words generated by the compiler. A memory block transfer is executed, wherein the memory block transfer is initiated by a control word from the stream of wide control words, and wherein data for the memory block transfer is moved independently from the array of compute elements.

The system block diagram 300 can include an array of compute elements 310. Discussed throughout, the compute elements within the array can be implemented using techniques including central processing units (CPUs), graphics processing units (GPUs), application specific integrated circuits (ASICs), field programmable gate arrays (FPGAs), processing cores, or other processing components or combinations of processing components. The compute elements can further include heterogeneous processors, homogeneous processors, processor cores within an integrated circuit or chip, etc. The array can further interface with other elements such as controllers, storage elements, ALUs, memory management units (MMUs), GPUs, multiplier elements, and so on.

The system block diagram can include one or more control words 320. The one or more control words can be generated by the compiler. Noted previously, the compiler which generates the control words can include a general-purpose compiler such as a C, C++, or Python compiler; a hardware description language compiler such as a VHDL or Verilog compiler; a compiler written for the array of compute elements; and the like. In embodiments, the wide control words comprise wide, variable length control words. The compiler can be used to map functionality such as processing functionality to the array of compute elements. A control word generated by the compiler can be used to configure one or more CEs within the array of compute elements, to enable data to flow to or from the CE, to configure the CE to perform an operation, and so on. Depending on the type and size of a task that is compiled to control the array of compute elements, one or more of the CEs can be controlled, while other CEs are unneeded by the particular task. The control words can configure the compute elements and other elements within the array; enable or disable individual compute elements or rows and/or columns of compute elements; load and store data; route data to, from, and among compute elements; etc.

The one or more wide control words can include one or more fields. The fields can include parameters associated with one or more memory block transfers. The block transfers can include block transfers associated with cache memory. A control word can include a source address 322. The source address can include an address within a cache memory, a memory system, and so on. The cache memory can comprise a multilevel cache, where the multilevel cache can include a level 1 (L1) cache, a level 2 (L2) cache, and a level 3 (L3) cache. The control word can further include a target address 324. The target address can include an address with a cache, a memory system, etc. The target address can be within the same cache as the source address, or can be in a different cache. A cache-to-cache transfer can be accomplished autonomously from the array of compute elements. The control word can include a block size 326. The block size can be based on a number of bits, bytes, words, etc. The control word can include a stride 328. A stride can include an increment or step size in memory units such as bytes between the beginnings of successive data elements such as words.

The system block diagram can include block transfer control logic 330. The block transfer control logic can control transfer memory blocks within a cache memory, between cache memories, between a cache memory and a memory system, and so on. In embodiments, the memory block transfer control logic can compute memory addresses. The memory addresses that can be computed can include absolute or direct addresses, indirect addresses, relative addresses, and so on. The memory addresses, such as a cache source location and a cache destination location, can be provided by the block transfer control logic. The memory addresses can comprise hybrid addresses, as discussed earlier. Discussed previously and throughout, the memory block transfer control logic can be implemented outside of the array of compute elements (as shown). The memory block transfer control logic can be operated using a “fire and forget” technique, where a control word is provided to the control logic. In embodiments, the memory block transfer control logic can operate autonomously from the array of compute elements. The memory block transfer control logic function can be based on elements of the array of compute elements. In embodiments, the memory block transfer control logic can be augmented by configuring one or more compute elements from the array of compute elements. The configuring the one or more compute elements can include scheduling compute elements. In embodiments, the configuring initializes compute element operation buffers within the one or more compute elements. The buffers can be used for data, control words, groupings of control words, and the like. In embodiments, the operation buffers comprise bunch buffers. The bunch buffers can store bunches of control words, bunches of bits associated with control words, etc.

The system block diagram can include a cache memory element 340. The cache memory element can comprise levels of cache, where each level of cache can be the same size as or larger than the previous level. The level can be as fast as or slower than the previous cache level. The cache levels can include a level 1 (L1) cache, a level 2 (L2) cache, and a level 3 (L3) cache. A memory block transfer operation will first seek a memory block to be transferred in the L1 cache. If the memory block is not in the L1 cache, then a “miss” occurs, and the memory block is sought in the L2 cache. If a miss occurs in the L2 cache, then the L3 cache is tried. If the memory block for transfer is not in the L3 cache, then a miss again occurs, and the memory block is sought in a memory system. A memory block transfer moves a memory block from a source location such as a cache source location 342 to a cache destination location 346. The memory block transfer can be based on a cache line move. The transfer can be performed using one or more of communication channels, buses, networks, etc., such as bus structure 344. In embodiments, the cache line move can transfer data on unidirectional line transfer buses.

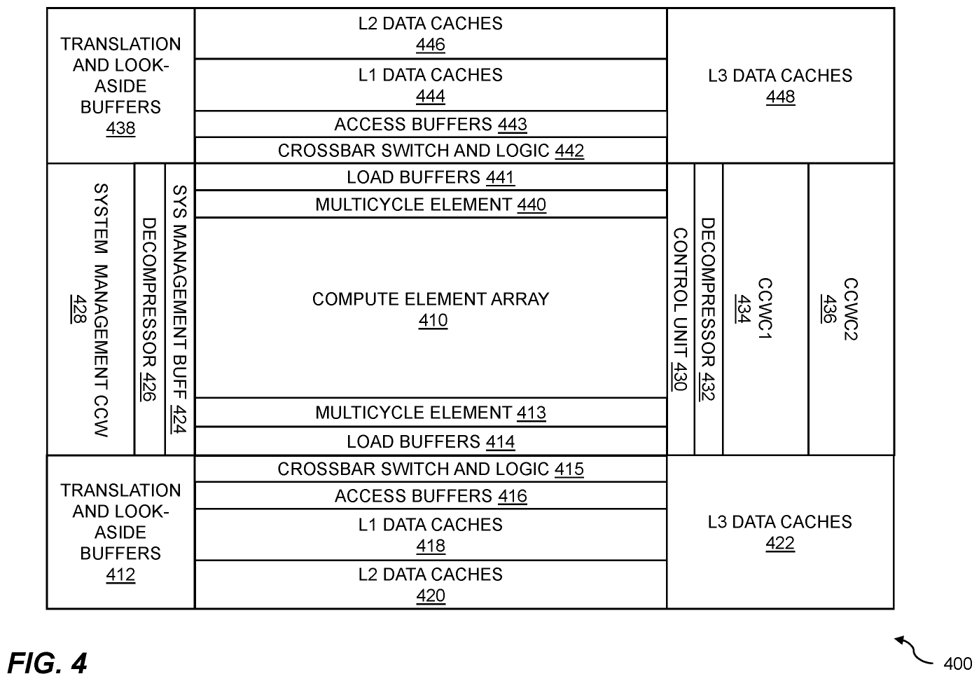

FIG. 4 illustrates a system block diagram for a highly parallel architecture with a shallow pipeline. The highly parallel architecture can comprise components including compute elements, processing elements, buffers, one or more levels of cache storage, system management, arithmetic logic units, multipliers, memory management units, and so on. The various components can be used to accomplish parallel processing of tasks, subtasks, and so on. The task processing is associated with program execution, job processing, etc. The task processing is enabled based on a parallel processing architecture with memory block transfers. An array of compute elements is accessed, wherein each compute element within the array of compute elements is known to a compiler and is coupled to its neighboring compute elements within the array of compute elements. Control for the array of compute elements is provided on a cycle-by-cycle basis, wherein the control is enabled by a stream of wide control words generated by the compiler. A memory block transfer is executed, wherein the memory block transfer is initiated by a control word from the stream of wide control words, and wherein data for the memory block transfer is moved independently from the array of compute elements.

A system block diagram 400 for a highly parallel architecture with a shallow pipeline is shown. The system block diagram can include a compute element array 410. The compute element array 410 can be based on compute elements, where the compute elements can include processors, central processing units (CPUs), graphics processing units (GPUs), coprocessors, and so on. The compute elements can be based on processing cores configured within chips such as application specific integrated circuits (ASICs), processing cores programmed into programmable chips such as field programmable gate arrays (FPGAs), and so on. The compute elements can comprise a homogeneous array of compute elements. The system block diagram 400 can include translation and look-aside buffers such as translation and look-aside buffers 412 and 438. The translation and look-aside buffers can comprise memory caches, where the memory caches can be used to reduce storage access times.

The system block diagram 400 can include logic for load and store access order and selection. The logic for load and store access order and selection can include crossbar switch and logic 415 along with crossbar switch and logic 442. Crossbar switch and logic 415 can accomplish load and store access order and selection for the lower data cache blocks (418 and 420), and crossbar switch and logic 442 can accomplish load and store access order and selection for the upper data cache blocks (444 and 446). Crossbar switch and logic 415 enables high-speed data communication between the lower-half compute elements of compute element array 410 and data caches 418 and 420 using access buffers 416. Crossbar switch and logic 442 enables high-speed data communication between the upper-half compute elements of compute element array 410 and data caches 444 and 446 using access buffers 443. The access buffers 416 and 443 allow logic 415 and logic 442, respectively, to hold, load, or store data until any memory hazards are resolved. In addition, splitting the data cache between physically adjacent regions of the compute element array can enable the doubling of load access bandwidth, the reducing of interconnect complexity, and so on. While loads can be split, stores can be driven to both lower data caches 418 and 420 and upper data caches 444 and 446.

The system block diagram 400 can include lower load buffers 414 and upper load buffers 441. The load buffers can provide temporary storage for memory load data so that it is ready for low latency access by the compute element array 410. The system block diagram can include dual level 1 (L1) data caches, such as L1 data caches 418 and 444. The L1 data caches can be used to hold blocks of load and/or store data, such as data to be processed together, data to be processed sequentially, and so on. The L1 cache can include a small, fast memory that is quickly accessible by the compute elements and other components. The system block diagram can include level 2 (L2) data caches. The L2 caches can include L2 caches 420 and 446. The L2 caches can include larger, slower storage in comparison to the L1 caches. The L2 caches can store “next up” data, results such as intermediate results, and so on. The L1 and L2 caches can further be coupled to level 3 (L3) caches. The L3 caches can include L3 caches 422 and 448. The L3 caches can be larger than the L2 and L1 caches and can include slower storage. Accessing data from L3 caches is still faster than accessing main storage. In embodiments, the L1, L2, and L3 caches can include 4-way set associative caches.

The system block diagram 400 can include lower multicycle element 413 and upper multicycle element 440. The multicycle elements (MEMs) can provide efficient functionality for operations, such as multiplication operations, that span multiple cycles. The MEMs can provide further functionality for operations that can be of indeterminant cycle length, such as some division operations, square root operations, and the like. The MEMs can operate on data coming out of the compute element array and/or data moving into the compute element array. Multicycle element 413 can be coupled to the compute element array 410 and load buffers 414, and multicycle element 440 can be coupled to compute element array 410 and load buffers 441.

The system block diagram 400 can include a system management buffer 424. The system management buffer can be used to store system management codes or control words that can be used to control the array 410 of compute elements. The system management buffer can be employed for holding opcodes, codes, routines, functions, etc. which can be used for exception or error handling, management of the parallel architecture for processing tasks, and so on. The system management buffer can be coupled to a decompressor 426. The decompressor can be used to decompress system management compressed control words (CCWs) from system management compressed control word buffer 428 and can store the decompressed system management control words in the system management buffer 424. The compressed system management control words can require less storage than the decompressed control words. The system management CCW component 428 can also include a spill buffer. The spill buffer can comprise a large static random-access memory (SRAM), which can be used to provide rapid support of multiple nested levels of exceptions.

The compute elements within the array of compute elements can be controlled by a control unit such as control unit 430. While the compiler, through the control word, controls the individual elements, the control unit can pause the array to ensure that new control words are not driven into the array. The control unit can receive a decompressed control word from a decompressor 432 and can drive out the decompressed control word into the appropriate compute elements of compute element array 410. The decompressor can decompress a control word (discussed below) to enable or idle rows or columns of compute elements, to enable or idle individual compute elements, to transmit control words to individual compute elements, etc. The decompressor can be coupled to a compressed control word store such as compressed control word cache 1 (CCWC1) 434. CCWC1 can include a cache such as an L1 cache that includes one or more compressed control words. CCWC1 can be coupled to a further compressed control word store such as compressed control word cache 2 (CCWC2) 436. CCWC2 can be used as an L2 cache for compressed control words. CCWC2 can be larger and slower than CCWC1. In embodiments, CCWC1 and CCWC2 can include 4-way set associativity. In embodiments, the CCWC1 cache can contain decompressed control words, in which case it could be designated as DCWC1. In that case, decompressor 432 can be coupled between CCWC1 434 (now DCWC1) and CCWC2 436.

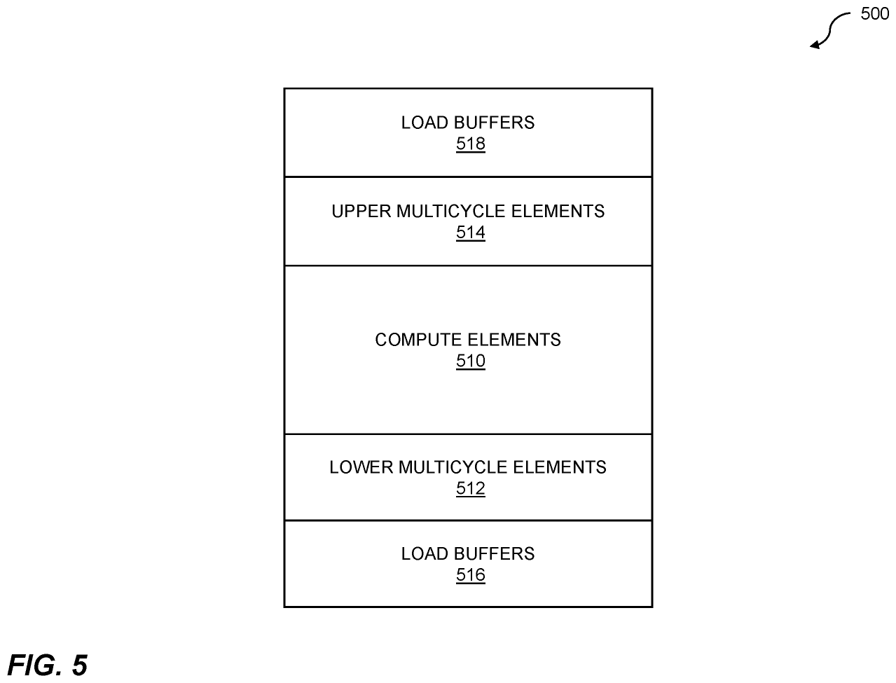

FIG. 5 shows compute element array detail 500. A compute element array can be coupled to components which enable the compute elements within the array to process one or more tasks, subtasks, and so on. The components can access and provide data, perform specific high-speed operations, and the like. The compute element array and its associated components enable a parallel processing architecture with memory block transfers. The compute element array 510 can perform a variety of processing tasks, where the processing tasks can include operations such as arithmetic, vector, matrix, or tensor operations; audio and video processing operations; neural network operations; etc. The compute elements can be coupled to multicycle elements such as lower multicycle elements 512 and upper multicycle elements 514. The multicycle elements can provide functionality to perform, for example, high-speed multiplications associated with general processing tasks, multiplications associated with neural networks such as deep learning networks, multiplications associated with vector operations, and so on. The multiplication operations can span multiple cycles. The MEMs can provide further functionality for operations that can be of indeterminant cycle length, such as some division operations, square root operations, and the like.

The compute elements can be coupled to load buffers such as load buffers 516 and load buffers 518. The load buffers can be coupled to the L1 data caches as discussed previously. In embodiments, a crossbar switch (not shown) can be coupled between the load buffers and the data caches. The load buffers can be used to load storage access requests from the compute elements. When an element is not explicitly controlled, it can be placed in the idle (or low power) state. No operation is performed, but ring buses can continue to operate in a “pass thru” mode to allow the rest of the array to operate properly. When a compute element is used just to route data unchanged through its ALU, it is still considered active.

While the array of compute elements is paused, background loading of the array from the memories (data memory and control word memory) can be performed. The memory systems can be free running and can continue to operate while the array is paused. Because multicycle latency can occur due to control signal transport that results in additional “dead time”, allowing the memory system to “reach into” the array and to deliver load data to appropriate scratchpad memories can be beneficial while the array is paused. This mechanism can operate such that the array state is known, as far as the compiler is concerned. When array operation resumes after a pause, new load data will have arrived at a scratchpad, as required for the compiler to maintain the statically scheduled model.

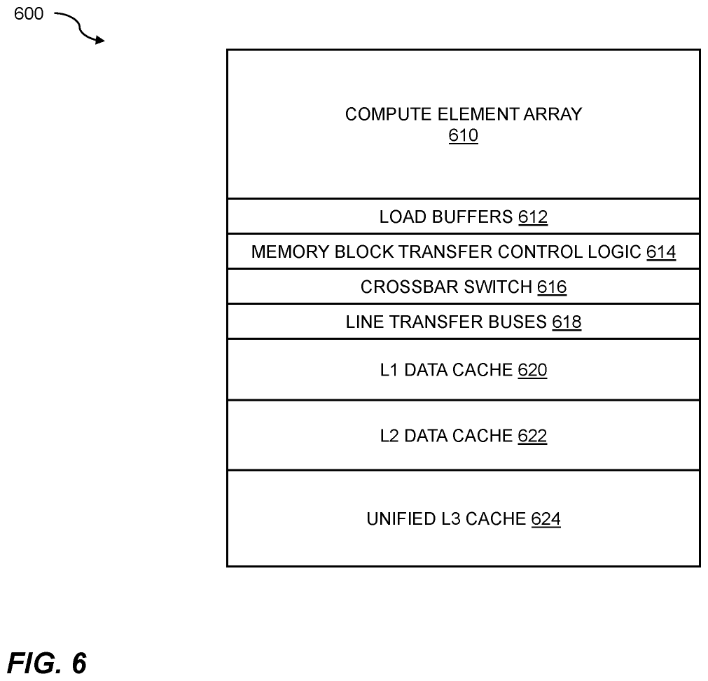

FIG. 6 illustrates memory-to-memory data movement array detail 600. Memory-to-memory moves can include transfers (moves) of data between storage elements. The storage elements can include a local storage coupled to one or more compute elements within an array of compute elements, storage associated with the array, cache storage, a memory system, and so on. A move can transfer control words, compressed control words, bunches of bits associated with control words, data, and the like. A memory-to-memory data transfer can include moving data between a cache such as a level 1 (L1) cache and a second L1 cache. Memory-to-memory data movement enables a parallel processing architecture with memory block transfers. An array of compute elements is accessed, wherein each compute element within the array of compute elements is known to a compiler and is coupled to its neighboring compute elements within the array of compute elements. Control for the array of compute elements is provided on a cycle-by-cycle basis, wherein the control is enabled by a stream of wide control words generated by the compiler. A memory block transfer is executed, wherein the memory block transfer is initiated by a control word from the stream of wide control words, and wherein data for the memory block transfer is moved independently from the array of compute elements.

The figure illustrates array detail for memory-to-memory data movement. The movement of data can be performed in order to supply data tasks, subtasks, and so on to be executed on an array. The array can include a two-dimensional array of compute elements 610. The movement of the data can be accomplished using a variety of techniques. In embodiments, an autonomous memory copy technique can be used to accomplish data movement. The autonomous memory copy technique can perform move operations outside of the array of compute elements, thereby freeing the compute elements to execute tasks, subtasks, etc. The autonomous data move can preload data needed by compute element. In additional embodiments, a semi-autonomous memory copy technique can be used for transferring data. The semi-autonomous memory copy can be accomplished by the array of compute elements which generates source and target addresses required for the one or more data moves. The array can further generate a data size such as 8, 16, 32, or 64-bit data sizes, and a striding value. The striding value can be used to avoid overloading a column of a storage component such as a cache memory. The source and target addresses, data size, and striding can be under direct control of a compiler. In further embodiments, the memory-to-memory data movement can be accomplished using a vector move technique. For this technique, aligned packet quantities such as 256-bit or 512-bit sizes can be moved between a cache memory and registers such as vector registers. The vector registers can be associated with one or more compute elements within the array. In other embodiments, the memory-to-memory data movement can be accomplished using a cache line move technique. Using this technique, data can be directly moved from a level 1 (L1) cache to a second L1 cache. The data movement can be accomplished by passing a crossbar switch (described below).

The array detail for data movement associated with the array of compute elements 610 can include load buffers 612. The load buffers can hold data destined for one or more compute elements within the array as the data is read from a memory such as cache memory. The load buffers can be used to accumulate an amount of data before transferring the data, to retime data arrival from storage to data transfer to compute elements, and the like. The array detail for data movement can include memory block transfer control logic 614. The memory block transfer control logic can accomplish a variety of functions, operations, and so on. In embodiments, the memory block transfer control logic can compute memory addresses. The memory addresses can be associated with a cache memory, a memory system, etc. In embodiments, the memory block transfer control logic can be implemented outside of the array of compute elements. The control logic can include a dedicated control element, a configurable control element, a programmable control element, and so on. In embodiments, the memory block transfer control logic can operate autonomously from the array of compute elements. The autonomous operation can be based on a “fire and forget” technique, where the control logic is provided with an arbitrary source or target address, move size, and stride. The source or target address, move size, and stride can be provided by the compiler. In other embodiments, the memory block transfer control logic can be augmented by configuring one or more compute elements from the array of compute elements. The one or more compute elements from the array can be configured by the compiler.

The array detail for data movement can include a crossbar switch 616. A crossbar switch can include an element, associated with the array of compute elements, with multiple inputs and multiple outputs between which connections can be made. In some crossbar switches, a connection can be made between any input and any output. A crossbar switch can be used for selecting data, shifting data, and the like. The crossbar switch can be used to route data associated with memory access requests to a target cache such as a data cache. The array detail for data movement can include one or more line transfer buses 618. The line transfer buses can be coupled between the crossbar switch and a cache memory. The line transfer buses can be used to accomplish a memory block transfer. In embodiments, the memory block transfer can include a cache line move. In embodiments, the cache line move can transfer data on unidirectional line transfer buses. The array detail for data movement can include a cache. The cache can include one or more levels such as a level 1 (L1) cache 620, a level 2 (L2) cache 622, a level 3 (L3) cache 624, and so on. The L1 cache can include a small, fast memory that is accessible to the compute elements within the array. The L2 cache can be larger than the L1 cache, and the L3 cache can be larger than the L2 cache and the L2 cache. When a compute element within the array initiates a load operation, the data associated with the load operation is first sought in the L1 cache, then the L2 cache if absent from the L1 cache, then the L3 cache if the load operation causes a “miss” (e.g., the requested data is not located in a cache level). The L1 cache, the L2 cache, and the L3 cache can store data, control words, compressed control words, and so on. In embodiments, the L3 cache can comprise a unified cache for data and compressed control words (CCWs).

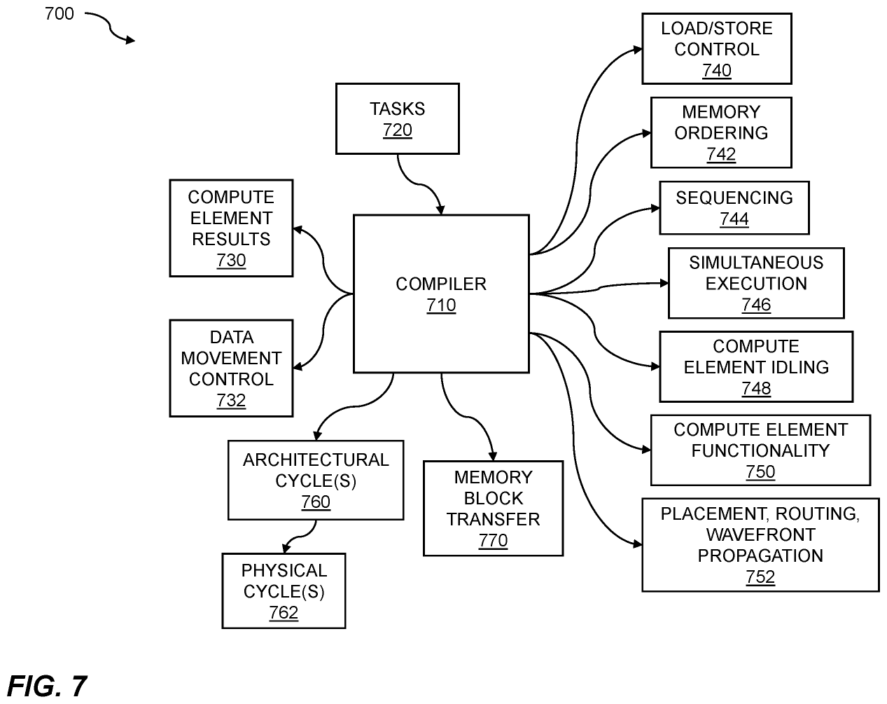

FIG. 7 illustrates a system block diagram for compiler interactions. Discussed throughout, compute elements within an array are known to a compiler which can compile tasks and subtasks for execution on the array. The compiled tasks and subtasks are executed to accomplish task processing. A variety of interactions, such as placement of tasks, routing of data, and so on, can be associated with the compiler. The compiler interactions enable a parallel processing architecture with block transfers. An array of compute elements is accessed, wherein each compute element within the array of compute elements is known to a compiler and is coupled to its neighboring compute elements within the array of compute elements. Control for the array of compute elements is provided on a cycle-by-cycle basis, wherein the control is enabled by a stream of wide control words generated by the compiler. A memory block transfer is executed, wherein the memory block transfer is initiated by a control word from the stream of wide control words, and wherein data for the memory block transfer is moved independently from the array of compute elements.

The system block diagram 700 includes a compiler 710. The compiler can include a high-level compiler such as a C, C++, Python, or similar compiler. The compiler can include a compiler implemented for a hardware description language such as a VHDL™ or Verilog™ compiler. The compiler can include a compiler for a portable, language-independent, intermediate representation such as low-level virtual machine (LLVM) intermediate representation (IR). The compiler can generate a set of directions that can be provided to the compute elements and other elements within the array. The compiler can be used to compile tasks 720. The tasks can include a plurality of tasks associated with a processing task. The tasks can further include a plurality of subtasks. The tasks can be based on an application such as a video processing or audio processing application. In embodiments, the tasks can be associated with machine learning functionality. The compiler can generate directions for handling compute element results 730. The compute element results can include results derived from arithmetic, vector, array, and matrix operations; Boolean operations; and so on. In embodiments, the compute element results are generated in parallel in the array of compute elements. Parallel results can be generated by compute elements when the compute elements can share input data, use independent data, and the like. The compiler can generate a set of directions that controls data movement 732 for the array of compute elements. The control of data movement can include movement of data to, from, and among compute elements within the array of compute elements. The control of data movement can include loading and storing data, such as temporary data storage, during data movement. In other embodiments, the data movement can include intra-array data movement.

As with a general-purpose compiler used for generating tasks and subtasks for execution on one or more processors, the compiler can provide directions for task and subtask handling, input data handling, intermediate and resultant data handling, and so on. The compiler can further generate directions for configuring the compute elements, storage elements, control units, ALUs, and so on, associated with the array. As previously discussed, the compiler generates directions for data handling to support the task handling. In the system block diagram, the data movement can include loads and stores 740 with a memory array. The loads and stores can include handling various data types such as integer, real or float, double-precision, character, and other data types. The loads and stores can load and store data into local storage such as registers, register files, caches, and the like. The caches can include one or more levels of cache such as a level 1 (L1) cache, a level 2 (L2) cache, a level 3 (L3) cache, and so on. The loads and stores can also be associated with storage such as shared memory, distributed memory, etc. In addition to the loads and stores, the compiler can handle other memory and storage management operations including memory precedence. In the system block diagram, the memory access precedence can enable ordering of memory data 742. Memory data can be ordered based on task data requirements, subtask data requirements, and so on. The memory data ordering can enable parallel execution of tasks and subtasks.

In the system block diagram 700, the ordering of memory data can enable compute element result sequencing 744. In order for task processing to be accomplished successfully, tasks and subtasks must be executed in an order that can accommodate task priority, task precedence, a schedule of operations, and so on. The memory data can be ordered such that the data required by the tasks and subtasks can be available for processing when the tasks and subtasks are scheduled to be executed. The results of the processing of the data by the tasks and subtasks can therefore be ordered to optimize task execution, to reduce or eliminate memory contention conflicts, etc. The system block diagram includes enabling simultaneous execution 746 of two or more potential compiled task outcomes based on the set of directions. The code that is compiled by the compiler can include branch points, where the branch points can include computations or flow control. Flow control transfers program execution to a different sequence of control words. Since the result of a branch decision, for example, is not known a priori, the initial operations associated with both paths are encoded in the currently executing control word stream. When the correct result of the branch is determined, then the sequence of control words associated with the correct branch result continues execution, while the operations for the branch path not taken are halted and side effects may be flushed. In embodiments, the two or more potential branch paths can be executed on spatially separate compute elements within the array of compute elements.

The system block diagram includes compute element idling 748. In embodiments, the set of directions from the compiler can idle an unneeded compute element within a row of compute elements located in the array of compute elements. Not all of the compute elements may be needed for processing, depending on the tasks, subtasks, and so on that are being processed. The compute elements may not be needed simply because there are fewer tasks to execute than there are compute elements available within the array. In embodiments, the idling can be controlled by a single bit in the control word generated by the compiler. In the system block diagram, compute elements within the array can be configured for various compute element functionalities 750. The compute element functionality can enable various types of compute architectures, processing configurations, and the like. In embodiments, the set of directions can enable machine learning functionality. The machine learning functionality can be trained to process various types of data such as image data, audio data, medical data, etc. In embodiments, the machine learning functionality can include neural network implementation. The neural network can include a convolutional neural network, a recurrent neural network, a deep learning network, and the like. The system block diagram can include compute element placement, results routing, and computation wave-front propagation 752 within the array of compute elements. The compiler can generate directions or operations that can place tasks and subtasks on compute elements within the array. The placement can include placing tasks and subtasks based on data dependencies between or among the tasks or subtasks, placing tasks that avoid memory conflicts or communications conflicts, etc. The directions can also enable computation wave-front propagation. Computation wave-front propagation can implement and control how execution of tasks and subtasks proceeds through the array of compute elements.

In the system block diagram, the compiler can control architectural cycles 760. An architectural cycle can include an abstract cycle that is associated with the elements within the array of elements. The elements of the array can include compute elements, storage elements, control elements, ALUs, and so on. An architectural cycle can include an “abstract” cycle, where an abstract cycle can refer to a variety of architecture level operations such as a load cycle, an execute cycle, a write cycle, and so on. The architectural cycles can refer to macro-operations of the architecture, rather than to low level operations. One or more architectural cycles are controlled by the compiler. Execution of an architectural cycle can be dependent on two or more conditions. In embodiments, an architectural cycle can occur when a control word is available to be pipelined into the array of compute elements and when all data dependencies are met. That is, the array of compute elements does not have to wait for either dependent data to load or for a full memory queue to clear. In the system block diagram, the architectural cycle can include one or more physical cycles 762. A physical cycle can refer to one or more cycles at the element level required to implement a load, an execute, a write, and so on. In embodiments, the set of directions can control the array of compute elements on a physical cycle-by-cycle basis. The physical cycles can be based on a clock such as a local, module, or system clock, or some other timing or synchronizing technique. In embodiments, the physical cycle-by-cycle basis can include an architectural cycle. The physical cycles can be based on an enable signal for each element of the array of elements, while the architectural cycle can be based on a global, architectural signal. In embodiments, the compiler can provide, via the control word, valid bits for each column of the array of compute elements, on the cycle-by-cycle basis. A valid bit can indicate that data is valid and ready for processing, that an address such as a jump address is valid, and the like. In embodiments, the valid bits can indicate that a valid memory load access is emerging from the array. The valid memory load access from the array can be used to access data within a memory or storage element. In other embodiments, the compiler can provide, via the control word, operand size information for each column of the array of compute elements. Various operand sizes can be used. In embodiments, the operand size can include bytes, half-words, words, and double-words.

In the system block diagram, the compiler can control memory block transfers 770. A memory block transfer can be initiated by a control word from the stream of wide control words that were generated by the compiler. Recall that the compiler can include a high-level compiler, a hardware-oriented compiler, a compiler oriented to the array of compute elements, and so on. In embodiments, the control word from the stream of wide control words can include a source address, a target address, a block size, and a stride. The source address can include an address within a cache memory or a memory system, and the block size can include a number of bytes. The stride can be used to distribute memory accesses across a cache, such as a data cache, in order to prevent memory accesses from simultaneously converging on a single data cache column. Embodiments can further include using memory block transfer control logic. The memory block transfer control logic can include control logic implemented outside the array. The memory block transfer control logic can be augmented by configuring compute elements within the array. The transfer control logic and the compute elements can be configured by the compiler. In embodiments, memory block transfer control logic can operate autonomously from the array of compute elements. Autonomous operation of the transfer control logic can enable operation of compute elements within the array to continue operation as the transfer control logic transfer memory blocks are provided to the array.

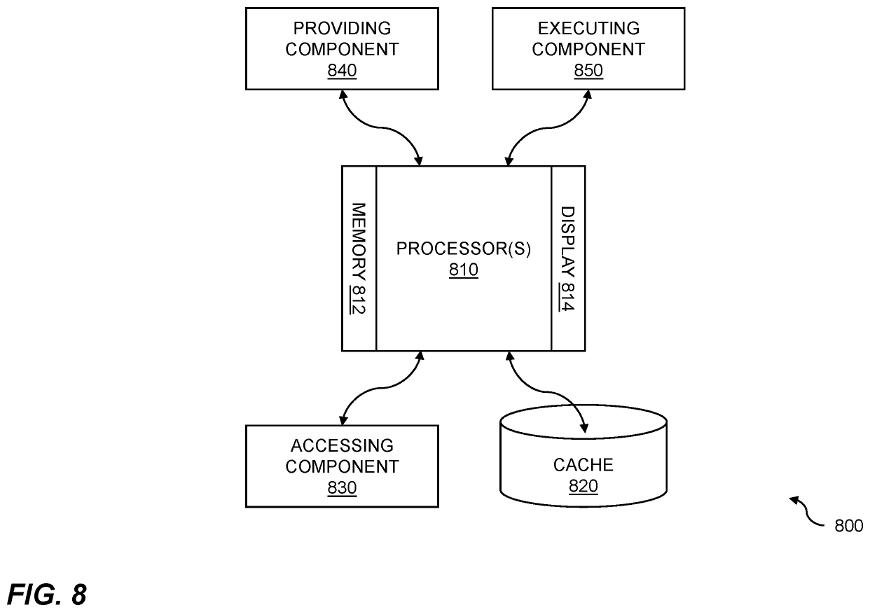

FIG. 8 is a system diagram for task processing. The task processing is enabled by a parallel processing architecture with memory block transfers. The system 800 can include one or more processors 810, which are attached to a memory 812 which stores instructions. The system 800 can further include a display 814 coupled to the one or more processors 810 for displaying data; memory block data, intermediate steps; directions; control words; compressed control words; control words implementing Very Long Instruction Word (VLIW) functionality; topologies including systolic, vector, cyclic, spatial, streaming, or VLIW topologies; and so on. In embodiments, one or more processors 810 are coupled to the memory 812, wherein the one or more processors, when executing the instructions which are stored, are configured to: access an array of compute elements, wherein each compute element within the array of compute elements is known to a compiler and is coupled to its neighboring compute elements within the array of compute elements; provide control for the array of compute elements on a cycle-by-cycle basis, wherein the control is enabled by a stream of wide control words generated by the compiler; and execute a memory block transfer, wherein the memory block transfer is initiated by a control word from the stream of wide control words, and wherein data for the memory block transfer is moved independently from the array of compute elements. The compute elements can include compute elements within one or more integrated circuits or chips; compute elements or cores configured within one or more programmable chips such as application specific integrated circuits (ASICs); field programmable gate arrays (FPGAs); heterogeneous processors configured as a mesh; standalone processors; etc.

The system 800 can include a cache 820. The cache 820 can be used to store data such as transfer data associated with a memory block, memory addresses, information associated with load and/or store operations, memory block transfer status information, directions to compute elements, control words, intermediate results, microcode, branch decisions, and so on. The cache can comprise a small, local, easily accessible memory available to one or more compute elements. In embodiments, the data that is stored can include data associated with mapping a virtual register into at least two physical registers. Embodiments include storing relevant portions of a control word within the cache associated with the array of compute elements. The cache can be accessible to one or more compute elements. The cache, if present, can include a dual read, single write (2R1W) cache. That is, the 2R1W cache can enable two read operations and one write operation contemporaneously without the read and write operations interfering with one another.

The system 800 can include an accessing component 830. The accessing component 830 can include control logic and functions for accessing an array of compute elements. Each compute element within the array of compute elements is known to a compiler and is coupled to its neighboring compute elements within the array of compute elements. A compute element can include one or more processors, processor cores, processor macros, and so on. Each compute element can include an amount of local storage. The local storage can be accessible to one or more compute elements. Each compute element can communicate with neighbors, where the neighbors can include nearest neighbors or more remote “neighbors”. Communication between and among compute elements can be accomplished using a bus such as an industry standard bus, a ring bus, a network such as a wired or wireless computer network, etc. In embodiments, the ring bus is implemented as a distributed multiplexor (MUX).

The system 800 can include a providing component 840. The providing component 840 can include control and functions for providing control for the array of compute elements on a cycle-by-cycle basis, wherein the control is enabled by a stream of wide control words generated by the compiler. The control words can further include variable bit-length control words, compressed control words, and so on. The control words can be based on low-level control words such as assembly language words, microcode words, firmware words, and so on. The control words can be variable length, such that a different number of operations for a differing plurality of compute elements can be conveyed in each control word. The control of the array of compute elements on a cycle-by-cycle basis can include configuring the array to perform various compute operations. In embodiments, the stream of wide control words comprises variable length control words generated by the compiler. In embodiments, the stream of wide, variable length control words generated by the compiler provides direct, fine-grained control of the array of compute elements. The compute operations can include a read-modify-write operation. The compute operations can enable audio or video processing, artificial intelligence processing, machine learning, deep learning, and the like. The providing control can be based on microcode control words, where the microcode control words can include opcode fields, data fields, compute array configuration fields, etc. The compiler that generates the control can include a general-purpose compiler, a parallelizing compiler, a compiler optimized for the array of compute elements, a compiler specialized to perform one or more processing tasks, and so on. The providing control can implement one or more topologies such as processing topologies within the array of compute elements. In embodiments, the topologies implemented within the array of compute elements can include a systolic, a vector, a cyclic, a spatial, a streaming, or a Very Long Instruction Word (VLIW) topology. Other topologies can include a neural network topology. A control can enable machine learning functionality for the neural network topology.

In embodiments, the control word from the stream of wide control words can include a source address, a target address, a block size, and a stride. The target address can include an absolute address, a relative address, an indirect address, and so on. The block size can be based on a logical block size, a physical memory block size, and the like. In embodiments, the memory block transfer control logic can compute memory addresses. The memory addresses can be associated with memory coupled to the array of compute elements, shared memory, a memory system, etc. Further embodiments include using memory block transfer control logic. The memory block transfer control logic can include one or more dedicated logic blocks, configurable logic, etc. In embodiments, the memory block transfer control logic can be implemented outside of the array of compute elements. The transfer control logic can include a logic element coupled to the array. In other embodiments, the memory block transfer control logic can operate autonomously from the array of compute elements. In a usage example, a control word that includes a memory block transfer request can be provided to the memory block transfer control logic. The logic can execute the memory block transfer while the array of compute elements is processing control words, executing compute element operations, and the like. In other embodiments, the memory block transfer control logic can be augmented by configuring one or more compute elements from the array of compute elements. The compute elements from the array can provide interfacing operations between compute elements within the array and the memory block transfer control logic. In other embodiments, the configuring can initialize compute element operation buffers within the one or more compute elements. The compute element operation buffers can be used to buffer control words, decompressed control words, portions of control words, etc. In further embodiments, the operation buffers can include bunch buffers. Recall that control words are based on bits. Sets of control word bits called bunches can be loaded into buffers called bunch buffers. The bunch buffers are coupled to compute elements and can control the compute elements. The control word bunches are used to configure the array of compute elements, and to control the flow or transfer of data within and the processing of the tasks and subtasks on the compute elements within the array.

The system 800 can include an executing component 850. The executing component 850 can include control and functions for executing a memory block transfer, wherein the memory block transfer is initiated by a control word from the stream of wide control words, and wherein data for the memory block transfer is moved independently from the array of compute elements. The operations that can be performed can include arithmetic operations, Boolean operations, matrix operations, neural network operations, and the like. The operations can be executed based on the control words generated by the compiler. The control words can be provided to a control unit where the control unit can control the operations of the compute elements within the array of compute elements. Operation of the compute elements can include configuring the compute elements, providing data to the compute elements, routing and ordering results from the compute elements, and so on. In embodiments, the same decompressed control word can be executed on a given cycle across the array of compute elements. The control words can be decompressed to provide control on a per compute element basis, where each control word can be comprised of a plurality of compute element control groups or bunches. One or more control words can be stored in a compressed format within a memory such as a cache. The compression of the control words can greatly reduce storage requirements. In embodiments, the control unit can operate on decompressed control words. The executing operations contained in the control words can include distributed execution of operations. In embodiments, the distributed execution of operations can occur in two or more compute elements within the array of compute elements. Recall that the mapping of the virtual registers can include renaming by the compiler. In embodiments, the renaming can enable the compiler to orchestrate execution of operations using the physical register files.

In embodiments, the memory block transfer that is executed comprises a load and/or store forwarding operation. Discussed previously, the load and/or store forwarding operation can accomplish the memory block transfer without causing the memory block to pass through the compute element array. Data originating in the cache memory can traverse a crossbar switch, line transfer buses, or access buffers as the data is forwarded from a source address to a target address. The memory block transfer can therefore be accomplished without sending the memory block through the array. As a result, the array can continue execution operations associated with tasks and subtasks without having to stop the processing to accomplish the memory block transfer. In embodiments, the memory block transfer can include a cache line move. A line of a cache can be transferred to a register or register file, storage local to a compute element, and the like. The transfer can be accomplished using a bus, a channel, etc. In embodiments, the cache line move can transfer data on unidirectional line transfer buses. The unidirectional line transfer buses can include dedicated buses between the cache and the array. Further embodiments include tagging data to enable cache line movement. The tagging can include tagging data associated with a load operation. The tagging can include associating a tag such as a countdown tag with the load operation. The countdown tag can be monitored for status such as valid or expired. Load data with a valid tag can allow compute element operation (e.g., the data arrived before required for processing). Load data with an expired tag can halt compute element operation (e.g., the load data arrived late). In embodiments, the tagging data can be performed on data issuing from the array of compute elements. The tagging can be performed by the compiler.

The system 800 can include a computer program product embodied in a non-transitory computer readable medium for task processing, the computer program product comprising code which causes one or more processors to perform operations of: accessing of compute elements, wherein each compute element within the array of compute elements is known to a compiler and is coupled to its neighboring compute elements within the array of compute elements; providing control for the array of compute elements on a cycle-by-cycle basis, wherein the control is enabled by a stream of wide control words generated by the compiler; and executing a memory block transfer, wherein the memory block transfer is initiated by a control word from the stream of wide control words, and wherein data for the memory block transfer is moved independently from the array of compute elements.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, a quantum computer, an analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for task processing comprising:
accessing an array of compute elements, wherein each compute element within the array of compute elements is known to a compiler and is coupled to its neighboring compute elements within the array of compute elements;
providing control for the array of compute elements on a cycle-by-cycle basis, wherein the control is enabled by a stream of wide control words generated by the compiler; and
executing a memory block transfer, wherein the memory block transfer is initiated by a control word from the stream of wide control words, and wherein data for the memory block transfer is moved independently from the array of compute elements.

2. The method of claim 1 wherein the control word from the stream of wide control words includes a source address, a target address, a block size, and a stride.

3. The method of claim 2 further comprising using memory block transfer control logic.

4. The method of claim 3 wherein the memory block transfer control logic computes memory addresses.

5. The method of claim 3 wherein the memory block transfer control logic is implemented outside of the array of compute elements.

6. The method of claim 5 wherein the memory block transfer control logic operates autonomously from the array of compute elements.

7. The method of claim 3 wherein the memory block transfer control logic is augmented by configuring one or more compute elements from the array of compute elements.

8. The method of claim 7 wherein the configuring initializes compute element operation buffers within the one or more compute elements.

9. The method of claim 8 wherein the operation buffers comprise bunch buffers.

10. The method of claim 1 wherein the memory block transfer comprises a load and/or store forwarding operation.

11. The method of claim 1 wherein the memory block transfer comprises a cache line move.

12. The method of claim 11 wherein the cache line move transfers data on unidirectional line transfer buses.

13. The method of claim 11 further comprising tagging data to enable cache line movement.

14. The method of claim 13 wherein the tagging data is performed on data issuing from the array of compute elements.

15. The method of claim 1 further comprising notifying a control unit upon successful completion of the memory block transfer.

16. The method of claim 15 wherein successful completion of the memory block transfer occurs within an architectural cycle.

17. The method of claim 16 wherein the architectural cycle includes a plurality of clock cycles.

18. The method of claim 15 wherein the notifying is accomplished by polling the memory block transfer status.

19. The method of claim 1 wherein data for the memory block transfer is non-cacheable.

20. The method of claim 1 wherein the stream of wide control words comprises variable length control words generated by the compiler.

21. The method of claim 20 wherein the stream of wide, variable length, control words generated by the compiler provides direct, fine-grained control of the array of compute elements.

22. A computer program product embodied in a non-transitory computer readable medium for task processing, the computer program product comprising code which causes one or more processors to perform operations of:
accessing an array of compute elements, wherein each compute element within the array of compute elements is known to a compiler and is coupled to its neighboring compute elements within the array of compute elements;
providing control for the array of compute elements on a cycle-by-cycle basis, wherein the control is enabled by a stream of wide control words generated by the compiler; and
executing a memory block transfer, wherein the memory block transfer is initiated by a control word from the stream of wide control words, and wherein data for the memory block transfer is moved independently from the array of compute elements.

23. A computer system for task processing comprising:
a memory which stores instructions;
one or more processors coupled to the memory, wherein the one or more processors, when executing the instructions which are stored, are configured to:
access an array of compute elements, wherein each compute element within the array of compute elements is known to a compiler and is coupled to its neighboring compute elements within the array of compute elements;
provide control for the array of compute elements on a cycle-by-cycle basis, wherein the control is enabled by a stream of wide control words generated by the compiler; and
execute a memory block transfer, wherein the memory block transfer is initiated by a control word from the stream of wide control words, and wherein data for the memory block transfer is moved independently from the array of compute elements.
